(19) United States
(12) Patent Application Publication
(10) Pub. No.: US 2007/0293107 A1
(43) Pub. Date: Dec. 20, 2007

(54) Composite assembly and methods of making and using the same

(75) Inventors: Brian J. Follo, Anderson, SC (US); Frederick P. Isley, Seneca, SC (US)

Correspondence Address: WITHERS & KEYS, LLC, P. O. BOX 2049, MCDONOUGH, GA, 30253, US

(73) Assignee: Hexcel Corporation

(21) Appl. No.: 11/452,877

(22) Filed: Jun. 14, 2006

(51) Int. Cl. B32B 27/04; F41H 5/02

(52) U.S. Cl. 442/134; 89/36.02; 89/36.09; 428/911; 442/135

(57) ABSTRACT

Composite assemblies are disclosed. Methods of making and using composite assemblies are also disclosed.

### FIELD OF THE INVENTION

The present invention is directed to composite assemblies having antiballistic properties. The present invention is further directed to methods of making and using composite assemblies having antiballistic properties.

### BACKGROUND OF THE INVENTION

Armor systems are known. However, typical armor systems comprise either ceramic or metal plates in order to provide antiballistic properties to a strike face of the armor system. Ceramic and metal plates have a number of disadvantages. For example, metal plates add an undesirable amount of weight to any given armor system. Ceramic plates are relatively expensive and quite fragile. In the case of multiple hits on a given strike face, ceramic plates are problematic due to the decrease in ceramic plate integrity resulting from a single strike.

There is a need in the art for relatively lightweight composite assemblies having antiballistic properties and enhanced ability to withstand multiple hits on a given strike face.

### SUMMARY OF THE INVENTION

The present invention addresses some of the needs in the art discussed above by the discovery of composite assemblies having antiballistic properties. The composite assemblies of the present invention comprise a number of distinct layers that provide one or more properties to the composite assembly. For example, one layer may be used to slow down a given projectile, while another layer may be used to distort the projectile. In addition, one layer may be used to bond adjacent layers to one another, while another layer may be used to encapsulate one or more layers of the composite assembly.

Accordingly, the present invention is directed to composite assemblies having antiballistic properties. In one exemplary embodiment of the present invention, the composite assembly comprises a confined particulate structural layer comprising first and second major outer surfaces and a plurality of wall portions extending from the first major outer surface to the second major outer surface so as to form a plurality of compartments within the confined particulate structural layer; and a confined material positioned within the plurality of compartments, the confined material comprising particulate material within an optional first matrix material comprising an inorganic matrix material or an organic polymeric resin material; wherein the confined material comprises greater than about 85 wt % particulate material and occupies from about 50 to about 95 vol % of a compartment volume of the plurality of compartments.

In a further exemplary embodiment of the present invention, the composite assembly comprises a fiber-reinforced structural layer comprising a first layer comprising from about 25 to about 55 woven aramid fabric layers within a second matrix material, a second layer on one major surface of the first layer, the second layer comprising from about 1 to about 10 woven carbon fabric layers within a third matrix material, and a third layer on the first layer opposite the second layer, the third layer comprising from about 1 to about 4 woven carbon fabric layers within a fourth matrix material. The second, third, and fourth matrix materials may be selected so as to provide desired properties to each layer of the fiber-reinforced structural layer.

In yet a further exemplary embodiment of the present invention, the composite assembly comprises the above-described confined particulate structural layer in combination with the above-described fiber-reinforced structural layer. In this exemplary embodiment, the composite assembly may further comprise additional layers including, but not limited to, an adhesive film layer, a surfacing film layer, an encapsulating layer, or any combination thereof.

In one exemplary embodiment, the composite assembly of the present invention comprises (1) a confined particulate structural layer comprising first and second major outer surfaces and a plurality of wall portions extending from the first major outer surface to the second major outer surface so as to form a plurality of compartments within the confined particulate structural layer; (2) a confined material positioned within the plurality of compartments, the confined material comprising (i) particulate material and (ii) an optional first matrix material, the optional first matrix material comprising an inorganic matrix material or an organic polymeric resin material, wherein the confined material comprises greater than about 85 wt % particulate material, and occupies from about 50 to about 95 vol % of a compartment volume of the plurality of compartments; and (3) a fiber-reinforced structural layer on at least one of the first and second outer major surfaces, the fiber-reinforced structural layer comprising a first layer comprising one or more fabric layers within a second matrix material, and second and third layers on opposite major surfaces of the first layer, wherein each of the second and third layers independently comprises one or more fiber-containing structures within third and fourth matrix materials respectively.

In yet a further exemplary embodiment, the composite assembly of the present invention comprises (1) a confined particulate structural layer comprising first and second major outer surfaces and a plurality of wall portions extending from the first major outer surface to the second major outer surface so as to form a plurality of compartments within the confined particulate structural layer; (2) a confined material positioned within the plurality of compartments, the confined material comprising (i) particulate material within (ii) a first matrix material, the first matrix material comprising an inorganic matrix material or an organic polymeric resin material, wherein the confined material comprises greater than about 85 wt % particulate material, and occupies from about 50 to about 95 vol % of a compartment volume of the plurality of compartments; and (3) a fiber-reinforced structural layer on at least one of the first and second outer major surfaces, the fiber-reinforced structural layer comprising (i) a first layer comprising from about 25 to about 55 woven aramid fabric layers within a second matrix material, (ii) a second layer on one major surface of the first layer, the second layer comprising from 1 to 10 woven carbon fabric layers within a third matrix material, and (iii) a third layer on the first layer opposite the second layer, the third layer comprising from 1 to 10 woven carbon fabric layers within a fourth matrix material.

The present invention is also directed to methods of making composite assemblies having antiballistic properties. In one exemplary embodiment of the present invention, the method of making a composite assembly comprises the steps of bonding a first skin layer to a first major outer surface of a compartmentalized layer having a plurality of compartments extending substantially perpendicular to the first skin layer; filling the plurality of compartments with particulate material and a matrix material so that the particulate material occupies a majority of total compartment volume within the compartmentalized layer; and bonding a second skin layer to a second major outer surface of the compartmentalized layer opposite the first skin layer. The exemplary method of making a composite assembly may further comprise a number of additional steps so as to provide a composite assembly having numerous composite assembly layers.

Composite assemblies of the present invention may be used in a variety of application. In one desired embodiment, composite assemblies of the present invention are used as an antiballistic panel on a structure. Suitable structures include, but are not limited to, vehicles (e.g., military vehicles, commercial vehicles, etc.), buildings, wall structures, etc.

These and other features and advantages of the present invention will become apparent after a review of the following detailed description of the disclosed embodiments and the appended claims.

### BRIEF DESCRIPTION OF THE FIGURES

FIG. 1 depicts an exemplary composite panel of the present invention;

FIG. 2 depicts a frontal view of exemplary confined particulate structural layer 11 of exemplary composite panel 10 shown in FIG. 1 as viewed from direction A;

FIG. 3 depicts an exemplary composite assembly system for protecting a structure; and

FIG. 4 depicts another exemplary composite assembly system for protecting a structure.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

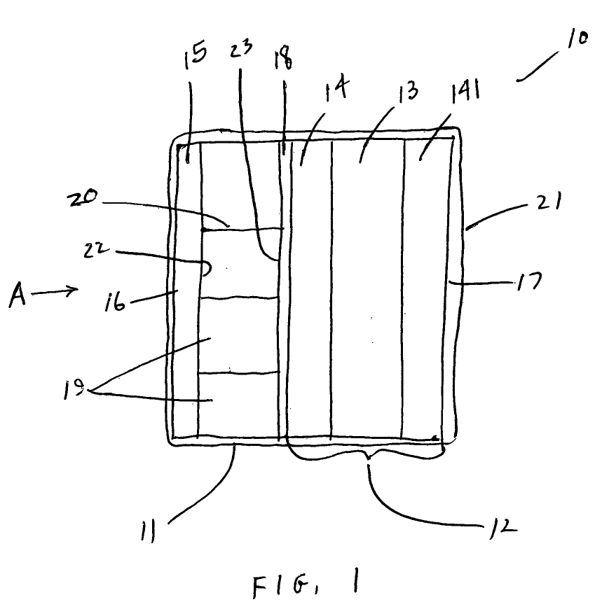

The present invention is directed to composite assemblies, methods of making composite assemblies, and method of using composite assemblies in a variety of applications. The composite assemblies of the present invention comprise a number of possible assembly components as shown in exemplary composite assembly 10 in FIG. 1. As shown in FIG. 1, exemplary composite assembly 10 comprises a confined particulate structural layer 11, a fiber-reinforced structural layer 12, an adhesive film layer 18, a surfacing film layer 15, and an encapsulating layer 21. Confined particulate structural layer 11 comprises a first major outer surface 23 and a second major outer surface 22 and a plurality of wall portions 20 extending from first major outer surface 23 to second major outer surface 22 so as to form a plurality of compartments 19 within confined particulate structural layer 11. A confined material is positioned within compartments 19 and comprises particulate material within an optional first matrix material such as, for example, an inorganic matrix material (e.g., a cementitious material) or an organic matrix material (e.g., a polymeric resin material).

As shown in exemplary composite assembly 10, the composite assemblies of the present invention may contain a variety of components. A detailed description of one or more components of the composite assemblies of the present invention is given below.

### I. Composite Assembly Components

The composite assemblies of the present invention may comprise one or more of the following components.

A. Confined Particulate Structural Layers

The composite assemblies of the present invention may comprise one or more confined particulate structural layers such as exemplary confined particulate structural layer 11 shown in FIG. 1. Each confined particulate structural layer 11 comprises first major outer surface 23 and second major outer surface 22 and a plurality of wall portions 20 extending from first major outer surface 23 to second major outer surface 22 so as to form a plurality of compartments 19 within each confined particulate structural layer 11. Each compartment 19 of a given confined particulate structural layer 11 is filled with particulate material and an optional matrix material (e.g., a thermoplastic resin material). A description of each component suitable for forming a given confined particulate structural layer and the overall properties of a given confined particulate structural layer is provided below.

1. Confined Particulate Structural Layer Materials

Each confined particulate structural layer comprises one or more of the following materials.

a. Plurality of Wall Portions

Each confined particulate structural layer comprises a plurality of wall portions extending from a first outer major surface to a second major outer surface of the confined particulate structural layer so as to form a plurality of compartments within the structural layer. The plurality of wall portions within a given confined particulate structural layer compartmentalize the confined particulate structural layer into separate compartments and confine materials within each compartment to a designated area/volume of the confined particulate structural layer. It has been discovered that compartmentalizing the confined particulate structural layer into a plurality of separate compartments provides numerous advantages to the resulting composite assembly, especially in antiballistic applications as discussed below.

Wall portions 20 may comprise any material capable of structurally supporting the weight of materials confined within a given compartment 19. Suitable materials for forming wall portions 20 include, but are not limited to, aluminum, stainless steel, titanium, nickel, fiber-reinforced resin, resin-impregnated or coated paper (e.g., epoxy coated paper), or any combination thereof. In one exemplary embodiment, wall portions 20 comprise aluminum or stainless steel, such as Hexcel Corporation's aluminum ACG-1/2 honeycomb having a layer thickness of about 2.54 cm (1 inch).

Each wall portion 20 may comprise a single layer of one or more of the above-described materials or two or more layers of similar or dissimilar materials. Wall portions 20 may form a continuous structure, such as a honeycomb structure, or may comprise two or more separate structures combined to form a single confined particulate structural layer comprising a plurality of compartments 19. When wall portions 20 comprise two or more layers (i.e., each compartment 19 has a single layer wall structure or more), each layer of a given wall portion 20 may be bonded to one another using any conventional adhesive (e.g., an epoxy-containing adhesive). When two or more separate structures are combined to form a single confined particulate structural layer comprising a plurality of compartments 19, the two or more separate structures may be bonded to one another using any conventional adhesive (e.g., an epoxy-containing adhesive).

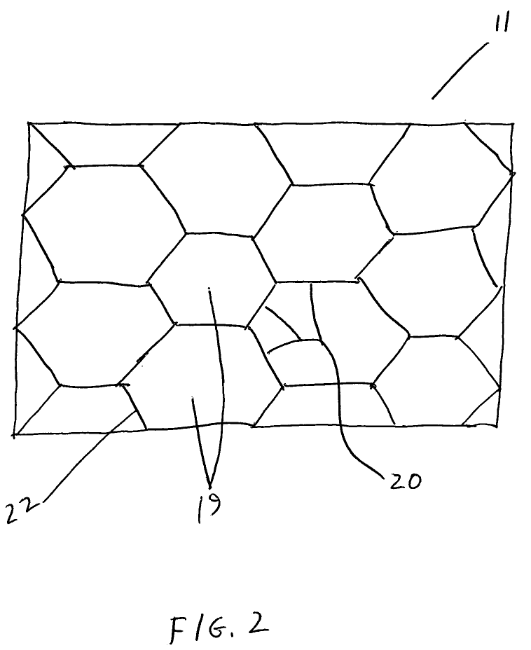

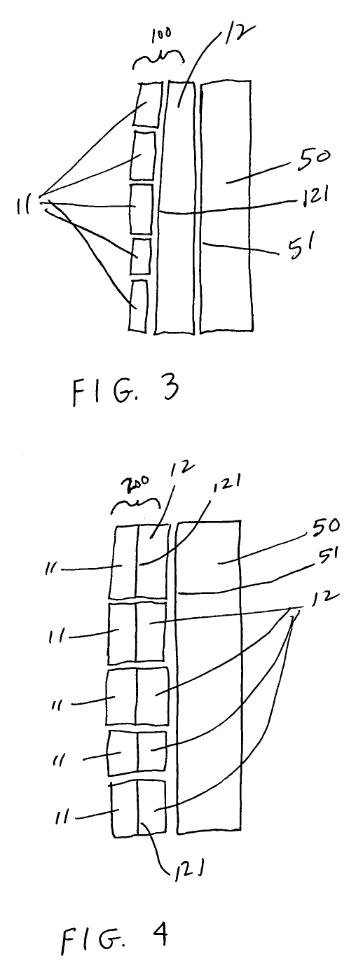

In one exemplary embodiment shown in FIG. 2, wall portions 20 comprise a continuous honeycomb structure. As shown in FIG. 2, each compartment 19 comprises six wall portions 20, wherein each wall portion 20 comprises a single or multi-layer structure. Although compartments 19 surrounded by wall portions 20 are shown having a hexagonal shape in FIG. 2, it should be understood that compartments 19 may comprise any suitable shape having any number of wall portions 20 from as little as 1 wall portion 20 (e.g., a circular structure) to any desired number. Wall portions 20 may form any desired shape including, but not limited to, hexagonal, circular, triangular, diamond, rectangular, pentagonal, or any combination thereof.

Each wall portion 20 may have an average wall thickness that varies depending on the requirements of a given wall structure (i.e., pressure capacity, size, height, holding power, etc.). Typically, each wall portion 20 has an average wall thickness of from about 0.2 to about 50 millimeters (mm). In one exemplary embodiment, each wall portion 20 has an average wall thickness of from about 0.1 to about 16 mm.

In an uncompressed or relaxed state, wall portions 20 have an average length extending from first major outer surface 23 to second major outer surface 22. As discussed in more detail below, in some embodiments, confined particulate structural layer 11 may be compressed so as to have an overall layer thickness less than an original layer thickness. In exemplary embodiments in which confined particulate structural layer 11 is compressed, an average length of wall portions 20 is greater than a distance from first outer major surface 23 to second major outer surface 22. It should be noted that the wall thickness of wall portion 20 remains substantially unchanged whether confined particulate structural layer 11 is compressed or uncompressed.

A total surface area of first major outer surface 23 or second major outer surface 22 of confined particulate structural layer 11 comprises a wall portion surface area and a compartment surface area. In one exemplary embodiment, the wall portion surface area is less than about 10% of the total surface area of confined particulate structural layer 11. In another exemplary embodiment, the wall portion surface area comprises less than about 2% of the total surface area of confined particulate structural layer 11.

The density of compartments along an outer surface of a given confined particulate structural layer 11 may be described in terms of compartments 19 per given square area. For example, in some embodiments of the present invention, confined particulate structural layer 11 comprises from about 775 to about 9300 compartments per square meter (m²) (about 72 to about 864 compartments per square foot (ft²)), more desirably, from about 1550 to about 6200 compartments per m² (about 144 to about 576 compartments per ft²). Alternatively, the density of compartments along an outer surface of a given confined particulate structural layer 11 may be described in terms of an average compartment surface area. In one exemplary embodiment, each compartment 19 has an average compartment surface area of less than about 929 square centimeter (cm²), desirably, less than about 103 cm², and more desirably, from about 3.4 cm² to about 103 cm².

In an exemplary embodiment, wall portions 19 provide structural integrity to compartment 19 such that when a projectile (e.g., bullet) impacts a given compartment 19, damage is limited to the given compartment 19 or the given compartment 19 and a small number of compartments 19 surrounding the given compartment 19 rather than damaging the entire confined particulate structural layer 11. In at least one exemplary embodiment, wall portions 20 are able to limit damage to a single compartment 19 when impacted by a projectile (e.g., bullet) such that adjoining compartments 19 are not damaged.

b. Confined Particulate Material

Each confined particulate structural layer 11 further comprises particulate material within compartments 19 surrounded by plurality of wall portions 20. A wide variety of particulate materials may be used in the present invention. Suitable particulate materials include, but are not limited to, ceramic powders, ceramic microspheres, glass microspheres, silicon carbide, granulated garnet or other hard gemstones, and any combination thereof. In one exemplary embodiment, the particulate material comprises silicon carbide commercially available from Saint Gobain (Louisville, Ky.) under the trade designation SIKATECH 15FCPC. In another exemplary embodiment, the particulate material comprises a mixture of silicon carbide particles and boron carbide particles.

The particulate material may comprise particles typically having an average particle size (i.e., largest dimension) ranging from about 0.05 μm to about 20 mm. In one exemplary embodiment, the particulate material used in the present invention has an average particle size ranging from about 0.5 μm to about 6 mm. In various exemplary embodiments, the particulate material may have a bimodal, trimodal, or other multi-modal particle size distribution such that large particles and small particles are used in combination with one another so as to occupy a higher percent of a total compartment volume. For example, a first set of particles having an average particle size of about 0.5 μm may be combined with a second set of particles having an average particle size of about 4 mm.

In some embodiments, it is desirable for the confined material to comprise a substantial amount of particulate material. In one exemplary embodiment, the confined material comprises greater than about 85 wt % particulate material based on a total weight of the confined material. In other exemplary embodiments, the confined material comprises greater than about 90 wt % particulate material (or about 91, or about 92, or about 93, or about 94, or about 95, or about 96, or about 97, or about 98, or about 99, or 100 wt % particulate material) based on a total weight of the confined material.

Further, in some embodiments, it is desirable for the particulate material to occupy a substantial amount of a total compartment volume within a given confined particulate structural layer. In one exemplary embodiment, the particulate material occupies greater than about 50 vol % of the total compartment volume within a given confined particulate structural layer. In other exemplary embodiments, the particulate material occupies greater than about 85 vol % of the total compartment volume within a given confined particulate structural layer. In yet other exemplary embodiments, the particulate material occupies greater than about 90 vol % (or about 91, or about 92, or about 93, or about 94, or about 95, or about 96, or about 97, or about 98, or about 99 vol %) of the total compartment volume within a given confined particulate structural layer.

In one exemplary embodiment, the confined material comprises loose particulate material without any additional matrix component. As used herein, the term “loose particulate material” is used to describe particulate material that is not bound together within a matrix material or via a particle surface coating. The particulate material does not conglomerate or bond to one another. In this embodiment, the compartments of the confined particulate structural layer contain only particulate material, and are substantially free of any other component that would tend to cause the particulate material to adhere to one another (e.g., water, bonding agents, polymers, surfactants, etc.). In this embodiment, the loose particulate material would flow freely out of a given compartment if not confined within the compartment via opposing skin layers (described below).

c. Confined Resin Material

Each confined particulate structural layer may also comprise at least one resin material within compartments 19 formed by plurality of wall portions 20. The resin material may be used to adhere particles to one another so as to form confined shapes of particulate material in a resin matrix. A variety of resin materials may be used in the present invention depending on a given application for the composite assembly. Suitable resin materials include, but are not limited to, polyamides, polyolefins, polyesters, thermoplastic resins, elastomeric resins, and combinations thereof. In one exemplary embodiment, the polymeric resin material comprises one or more thermoplastic or elastomeric materials.

In one exemplary embodiment, resin material and particulate material form substantially 100 wt % of a total weight of the confined shape. Typically, the confined shapes comprise up to about 50 wt % resin material and greater than about 50 wt % particulate material, based on the total weight of the confined shapes. Desirably, the confined shapes comprise from about 15.0 to about 40 wt % resin material and from about 60 to about 85 wt % particulate material, based on the total weight of the confined shapes, when a resin matrix material is present.

In one exemplary embodiment, a thermoplastic resin material having a low viscosity (i.e., less than 1000 cP) is used to bind the particulate material within compartments 19. In one desired embodiment, methyl methacrylate is used as the thermoplastic resin material. In other exemplary embodiments, low viscosity polyester, vinylester, and urethanes may be used as the thermoplastic resin material.

d. Inorganic Matrix Material

In addition to or separate from the above materials, compartments 19 may be filled with a solids-filled inorganic matrix material such as a high strength concrete or a blend of high strength concrete with hardened solids (e.g., the above-described particulate materials). In this exemplary embodiment, the confined shaped within compartments 19 may be substantially free of thermoplastic resin material or may comprise an effective amount of thermoplastic resin material so as to provide elasticity to the confined shaped.

In a further exemplary embodiment, an inorganic matrix material in the form of a castable silicon carbide ceramic commercially available from Cotronics Corporation (Brooklyn, N.Y.) under the trade designation RESCOR™ 770 may be used to fill the plurality of compartments. In this embodiment, the ceramic material is allowed to cure at room temperature for about 16 hours. A post-cure treatment of heating the ceramic material at 927° C. (1700° F.) for about 2 hours is used to harden the ceramic material.

e. Skin Layers

Skin layers (not shown) may be used to cover first major outer surface 23, second major outer surface 22, or both during manufacture of confined particulate structural layer 11. Skin layers may be temporarily applied to first major outer surface 23, second major outer surface 22, or both, during manufacture of confined particulate structural layer 11 so that the skin layers are removed after manufacture of confined particulate structural layer 11. In other embodiments, skin layers remain as permanent components of confined particulate structural layer 11.

Skin layers may comprise any material capable of preventing particulate material and/or resin material from escaping compartments 19 during manufacture of confined particulate structural layer 11. Suitable skin layers include, but are not limited to, polymer film layers, fabric layers (e.g., woven, nonwoven, and knit layers), fiber-reinforced resin layers, metal foil layers, etc. In one exemplary embodiment, the skin layers comprise resin impregnated woven carbon fabrics commercially available from Hexcel Corporation (Stamford, Conn.) under the trade designation TowFlex®, such as TowFlex® TFF AS4 491: 2×2 TW/N6 38% (e.g., a woven carbon fabric comprising AS4 carbon fiber in a 2×2 twill weave and impregnated with 38 wt % nylon 6 resin based on a total weight of the skin layer).

2. Confined Particulate Structural Layer Physical Properties

Each confined particulate structural layer 11 desirably possesses the following physical properties.

a. Layer Thickness

Each confined particulate structural layer 11 has a thickness (i.e., the distance from first outer major surface 23 to second major outer surface 22) that may vary depending upon a given application for the composite assembly. Typically, each confined particulate structural layer 11 has an original layer thickness of up to about 10.2 cm (4.0 in), desirably, from about 1.3 cm (0.5 in) to about 7.6 cm (3.0 in). In one desired embodiment, each confined particulate structural layer 11 within the composite assembly of the present invention has an original layer thickness of about 2.5 cm (1.0 in).

In some embodiments, it may be desirable to compress a given confined particulate structural layer 11 prior to assembling one or more confined particulate structural layers 11 with any additional layers to form a composite assembly. In other embodiments, each confined particulate structural layer 11 is compressed after assembling one or more confined particulate structural layers 11 with any additional layers to form a composite assembly. In one exemplary embodiment, one or more confined particulate structural layers 11 are compressed so as to decrease an original layer thickness by as much as about 40%. When compressed, each confined particulate structural layer 11 is typically compressed so as to result in a compressed layer thickness of from about 1.3 cm (0.5 in) to about 2.5 cm (1.0 in).

b. Layer Density

Each confined particulate structural layer 11 has an uncompressed layer density that varies depending upon a given application for the composite assembly. Typically, each confined particulate structural layer 11 has an uncompressed layer density of from about 1.2 to about 3.2 g/cm³. In one desired embodiment, each confined particulate structural layer 11 within the composite assembly of the present invention has an uncompressed layer density of about 1.4 g/cm³.

As discussed above, in some embodiments, it may be desirable to compress a given confined particulate structural layer 11 prior to or after assembling one or more confined particulate structural layers 11 with any additional layers to form a composite assembly. Typically, when compressed, the resulting confined particulate structural layer 11 has a compressed layer density of from about 1.6 to about 2.0 g/cm³. In one desired embodiment, each confined particulate structural layer 11 within the composite assembly of the present invention has a compressed layer density of about 1.8 g/cm³.

c. Layer Basis Weight

Each confined particulate structural layer 11 has a layer basis weight that varies depending upon a given application for the composite assembly. Typically, each confined particulate structural layer 11 has a layer basis weight of from about 2.0 to about 4.0 g/cm². In one desired embodiment, each confined particulate structural layer 11 within the composite assembly of the present invention has a layer basis weight of about 3.9 g/cm².

B. Fiber-Reinforced Structural Layers

The composite assemblies of the present invention may further comprise one or more fiber-reinforced structural layers such as exemplary fiber-reinforced structural layer 12 shown in FIG. 1. As shown in FIG. 1, exemplary fiber-reinforced structural layer 12 comprises three separate components: a first layer 13, a second layer 14 on one major surface of first layer 13, and a third layer 141 on first layer 13 opposite second layer 14. Each of first layer 13, second layer 14, and third layer 141 provides structural integrity to exemplary fiber-reinforced structural layer 12 and composite assemblies made therefrom.

A description of each component of a given fiber-reinforced structural layer and overall properties of a given fiber-reinforced structural layer is provided below.

1. Fiber-Reinforced Structural Layer Materials

Each fiber-reinforced structural layer comprises a first layer (e.g., first layer 13), a second layer (e.g., second layer 14) on one major surface of the first layer, and a third layer (e.g., third layer 141) on the first layer opposite the second layer. Each layer of a given fiber-reinforced structural layer is described below.

a. First Layer

Referring to exemplary fiber-reinforced structural layer 12 shown in FIG. 1, first layer 13 comprises fibrous reinforcements within a first layer resin material. Suitable fibrous reinforcements and first layer resin materials are provided below.

i. First Layer Fibrous Reinforcements

First layer 13 of exemplary fiber-reinforced structural layer 12 comprises one or more fiber-containing layers. Suitable fiber-containing layers include, but are not limited to, woven fabrics, nonwoven fabrics, knitted fabrics, unidirectional fabrics, or a combination thereof. The fiber-containing layers may be formed from a variety of fibers including, but not limited to, polymeric fibers (e.g., high strength polypropylene fibers or PEEK fibers), aramid fibers (e.g., KEVLAR® fibers), glass fibers, ceramic fibers, carbon fibers, metallic fibers, natural fibers, or a combination thereof.

First layer 13 typically comprises multiple fiber-containing layers depending on a given application for the resulting composite assembly. In some embodiments, first layer 13 comprises from about 2 to about 55 fiber-containing layers. In other embodiments, first layer 13 comprises from about 10 to about 40 fiber-containing layers. In other embodiments, first layer 13 comprises from about 20 to about 35 fiber-containing layers.

In one exemplary embodiment, first layer 13 comprises from about 10 to about 55 woven aramid fabric layers within a first layer matrix material. In another exemplary embodiment, first layer 13 comprises from about 25 to about 35 woven aramid fabric layers within a first layer matrix material.

ii. First Layer Matrix Materials

A variety of first layer matrix materials may be used in combination with the above-described fiber-containing layers to form first layer 13 of exemplary fiber-reinforced structural layer 12. Suitable first layer matrix materials include, but are not limited to, a polyolefin resin such as polypropylene, copolymers of propylene and ethylene; polyamides such as Nylon 6; polyesters; thermosettable materials (e.g., epoxies); elastomeric resins (e.g., styrene-butadiene copolymers); and combinations thereof. In one desired embodiment, the first layer matrix material comprises one or more thermoplastic resins, such as a polypropylene resin.

In one exemplary embodiment for applications in which the composite assembly is subjected to temperatures less than about 200° C., the first layer matrix material desirably comprises a high density polypropylene resin. See, for example, suitable fiber-reinforced materials commercially available from Hexcel Corporation (Stamford, Conn.) under the trade designation TowFlex®, such as TowFlex® TFF-CPP- 100 (e.g., a woven 2×2 twill carbon fabric impregnated with 38 wt % polypropylene resin based on a total weight of the fiber-reinforced material). For applications in which the composite assembly is subjected to temperatures greater than about 200° C., the first layer matrix material desirably comprises Nylon 6 resin. See, for example, TowFlex® TFF-CN6-100 (e.g., a woven 2×2 twill carbon fabric impregnated with 38 wt % nylon 6 resin based on a total weight of the fiber-reinforced material) also commercially available from Hexcel Corporation (Stamford, Conn.). See other similar products suitable for use in the present invention at www.hexcel.com/Products/Downloads/Thermoplastics%20-Data%20Sheets.

The resin/fiber content for first layer 13 may vary depending on a number of factors including, but not limited to, the type of fiber-containing layer used, the type of resin used, the desired weight of first layer 13, and the particular application. In one exemplary embodiment, first layer 13 comprises less than about 40 wt % of first layer matrix material based on a total weight of first layer 13 (i.e., the weight of the first layer resin material and the fiber-containing layer(s)). In a further exemplary embodiment, first layer 13 comprises from about 15 to about 35 wt % of first layer matrix material based on a total weight of first layer 13. In one desired embodiment, first layer 13 comprises from about 15 to about 20 wt % of a first layer matrix material comprising polypropylene and from about 85 to about 80 wt % of woven aramid fabrics based on a total weight of first layer 13.

b. Second Layer

Second layer 14 comprises fibrous reinforcements within a second layer resin matrix. Suitable fibrous reinforcements and second layer resin materials are provided below.

i. Second Layer Fibrous Reinforcements

Second layer 14 of exemplary fiber-reinforced structural layer 12 comprises one or more fiber-containing layers. Suitable fiber-containing layers and fibers include, but are not limited to, the above-described fiber-containing layers and fibers suitable for use in first layer 13. In one exemplary embodiment, second layer 14 differs from first layer 13 in the type of fiber-containing layers used, the type of fibers used, the number of fiber-containing layers used, or any combination thereof.

Second layer 14 typically comprises from about 1 to about 10 fiber-containing layers such as woven fabric layers, nonwoven fabric layers, unidirectional fabric layers, or combinations thereof. More typically, second layer 14 comprises from about 1 to about 4 fiber-containing layers. In one desired embodiment, second layer 14 comprises from about 1 to about 4 woven carbon fabric layers within a second layer matrix material.

ii. Second Layer Matrix Materials

A variety of second layer matrix materials may be used in combination with the above-described fiber-containing layers to form second layer 14 of exemplary fiber-reinforced structural layer 12. Suitable second layer matrix materials include, but are not limited to, the above-described resin materials suitable for use in forming first layer 13. In one desired embodiment, the second layer matrix material comprises one or more thermoplastic resins, such as a polyamide resin (e.g., Nylon 6). One such suitable second layer matrix material comprises nylon 6 resin provided in the above-described TowFlex® TFF-CN6-100 product commercially available from Hexcel Corporation (Stamford, Conn.).

The resin/fiber content for second layer 14 may vary depending on a number of factors including, but not limited to, the type of fiber-containing layer used, the type of resin used, the desired weight of second layer 14, and the particular application. In one exemplary embodiment, second layer 14 comprises greater than about 30 wt % of second layer matrix material based on a total weight of second layer 14 (i.e., the weight of the second layer resin material and the fiber-containing layer(s)). In a further exemplary embodiment, second layer 14 comprises from about 30 to about 60 wt % of second layer matrix material based on a total weight of second layer 14. In one desired embodiment, second layer 14 comprises about 35 wt % of a second layer matrix material comprising Nylon 6 and about 65 wt % of woven carbon fabric(s) based on a total weight of second layer 14.

c. Third Layer

Third layer 141 comprises fibrous reinforcements within a third layer resin matrix. Suitable fibrous reinforcements and third layer resin materials are provided below.

i. Third Layer Fibrous Reinforcements

Third layer 141 of exemplary fiber-reinforced structural layer 12 comprises one or more fiber-containing layers. Suitable fiber-containing layers and fibers include, but are not limited to, the above-described fiber-containing layers and fibers suitable for use in first layer 13 and second layer 14. In one exemplary embodiment, third layer 141 differs from second layer 14 and/or first layer 13 in the type of fiber-containing layers used, the type of fibers used, the number of fiber-containing layers used, or any combination thereof. In another exemplary embodiment, third layer 141 is substantially similar to second layer 14 in regard to the type of fiber-containing layers used, the type of fibers used, and the number of fiber-containing layers used.

Third layer 141 typically comprises from about 1 to about 10 fiber-containing layers such as woven fabric layers, nonwoven fabric layers, unidirectional fabric layers, or combinations thereof. More typically, third layer 141 comprises from about 1 to about 4 fiber-containing layers. In one desired embodiment, third layer 141 comprises from about 1 to about 4 woven carbon fabric layers within a third layer matrix material.

ii. Third Layer Matrix Materials

A variety of third layer matrix materials may be used in combination with the above-described fiber-containing layers to form third layer 141 of exemplary fiber-reinforced structural layer 12. Suitable third layer matrix materials include, but are not limited to, the above-described resin materials suitable for use in forming first layer 13. In one desired embodiment, the third layer matrix material comprises one or more thermoplastic resins, such as the above-described Nylon 6 resin.

The resin/fiber content for third layer 141 may vary depending on a number of factors including, but not limited to, the type of fiber-containing layer used, the type of resin used, the desired weight of third layer 141, and the particular application. In one exemplary embodiment, third layer 141 comprises greater than about 30 wt % of third layer matrix material based on a total weight of third layer 141 (i.e., the weight of the third layer resin material and the fiber-containing layer(s)). In a further exemplary embodiment, third layer 141 comprises from about 30 to about 60 wt % of third layer matrix material based on a total weight of third layer 141. In one desired embodiment, third layer 141 comprises about 35 wt % of a third layer matrix material comprising Nylon 6 and about 65 wt % of woven carbon fabric(s) based on a total weight of third layer 141.

Suitable products for forming third layer 141 include, but are not limited to, one or more of the above-described TowFlex® products commercially available from Hexcel Corporation (Stamford, Conn.) such as TowFlex® TFF-CPP-100 and TowFlex® TFF-CN6-100.

2. Fiber-Reinforced Structural Layer Physical Properties

Each fiber-reinforced structural layer (i.e., exemplary fiber-reinforced structural layer 12) desirably possesses the following physical properties and/or characteristics.

a. Fiber-Reinforced Structural Layer Thickness

Each of the first, second and third layers of a given fiber-reinforced structural layer (i.e., exemplary fiber-reinforced structural layer 12) contributes to an overall layer thickness that may vary depending on a given application. In one exemplary embodiment, the overall thickness of a given fiber-reinforced structural layer is less than about 4.0 cm. Typically the overall thickness of a given fiber-reinforced structural layer is from about 2.2 cm to about 3.5 cm.

Typically, first layer 13 represents greater than 50% of the overall layer thickness of a given fiber-reinforced structural layer. In one exemplary embodiment, first layer 13 has a first layer thickness of from about 2.0 cm to about 2.5 cm, second layer 14 has a second layer thickness of from about 0.2 cm to about 0.4 cm, and third layer 141 has a third layer thickness of from about 0.2 cm to about 0.4 cm.

b. Fiber-Reinforced Structural Layer Basis Weight

Each of the first, second and third layers of a given fiber-reinforced structural layer (i.e., exemplary fiber-reinforced structural layer 12) contributes to an overall basis weight that may vary depending on a given application. In one exemplary embodiment, the overall basis weight of a given fiber-reinforced structural layer is less than about 29.3 kg/m² (6.0 lb/ft²). Typically, the overall basis weight of a given fiber-reinforced structural layer is from about 17.1 kg/m² (3.5 lb/ft²) to about 24.4 kg/m² (5.0 lb/ft²).

Typically, first layer 13 represents greater than 50% of the overall layer basis weight of a given fiber-reinforced structural layer. In one exemplary embodiment, first layer 13 has a first layer basis weight of from about 17.1 kg/m² (3.5 lb/ft²) to about 18.6 kg/M² (3.8 lb/ft²), second layer 14 has a second layer basis weight of from about 1345 g/m² to about 1615 g/M², and third layer 141 has a third layer basis weight of from about 1345 g/m² to about 1615 g/m², In a further exemplary embodiment, first layer 13 represents about 83% of a total basis weight of a given fiber-reinforced structural layer, while second layer 14 and third layer 141 contribute about 17% of a total basis weight of a given fiber-reinforced structural layer.

C. Adhesive Layers

The composite assemblies of the present invention may further comprise one or more adhesive layers such as exemplary adhesive layer 18 shown in FIG. 1. One or more adhesive layers may be used to join separate layers to one another in the formation of a given composite assembly. Each adhesive layer may comprise an adhesive matrix material with or without optional fiber reinforcement. When fiber reinforcement is present, any of the above-mentioned fiber-containing layers may be used in combination with an adhesive matrix material.

A variety of adhesive materials may be used in the present invention. Suitable adhesive layer materials include, but are not limited to, polyurethanes, polyolefins, polyacrylates, epoxies, and combinations thereof. Suitable commercially available adhesive materials suitable for forming adhesive layers include, but are not limited to, polyurethane adhesives commercially available from OSI Sealants, Inc. (Mentor, Ohio) under the trade designation PL® construction adhesive.

In one exemplary embodiment, a heat-activatable adhesive layer may be used as a skin layer as described above in connection with the manufacture of a given confined particulate structural layer 11. In this exemplary embodiment, an adhesive skin layer may be used along first major outer surface 23 of confined particulate structural layer 11 so as to prevent confined particulate material from escaping compartments 19 during formation (or after construction) of confined particulate structural layer 11.

D. Surface Layers

The composite assemblies of the present invention may further comprise one or more surface layers such as exemplary surface layer 15 shown in FIG. 1. A variety of surface layer materials may be used in the present invention. Suitable surface layer materials include, but are not limited to, a film layer, a fiber-reinforced film layer, or a combination thereof. Suitable surface film layers include, but are not limited to, films formed from the following resin systems: resin systems commercially available from Hexcel Corporation (Stamford, Conn.) under the trade designations M21, M50, 8552, F593, F584, F161, M73 and M36, all of which are toughened epoxy resin systems; the trade designations F263, 913, M74, 3501-6 and REDUX® products, such as REDUX® 330, all of which are epoxy resin systems; the trade designations F655, HP655, F650, M61 and M62, all of which are bismaleimide (BMI) resin systems; the trade designation F 174, a polyimide resin system; and the trade designations 954-3A and 996, both of which are cyanate resin systems.

Suitable fiber reinforcements for use in a surface layer include, but are not limited to, glass woven fabrics commercially available from Hexcel Corporation (Stamford, Conn.) such as style numbers: 104 (basis weight—about 20 grams per square meter (gsm)), 106 (basis weight—about 25 gsm), 108 (basis weight—about 48 gsm), 112 (basis weight—about 71 gsm), and 120 (basis weight—about 107 gsm), all of which are E-glass woven fabrics; and 6012 (basis weight—about 36 gsm), 6013 (basis weight —about 39 gsm), 6014 (basis weight—about 43 gsm), 6080 (basis weight—about 48 gsm), 4180 (basis weight—about 84 gsm), 4522 (basis weight—about 123 gsm), and 6581 (basis weight—about 303 gsm), all of which are S-glass woven fabrics.

More coarsely woven fabrics or nonwoven fabrics may also be used. Typically, these fabrics are marketed under the common name of woven rovings, stitchbonded fabrics, adhesively- or heat-bonded fabrics, felts, etc. These type fabrics are commonly available under a variety of trade names and from a wide variety of suppliers.

In one exemplary embodiment, a surface film comprising glass woven fabric in an epoxy resin matrix is positioned over second major outer surface 22 of confined particulate structural layer 11 shown in FIG. 1. In this embodiment, the surface film may be used as a skin layer as described above in connection with the manufacture of a given confined particulate structural layer 11. The surface film layer may be used along second major outer surface 22 of confined particulate structural layer 11 so as to prevent confined particulate material from escaping compartments 19 during formation (or after construction) of confined particulate structural layer 11.

E. Encapsulating Layers

The composite assemblies of the present invention may even further comprise one or more encapsulating layers such as exemplary encapsulating layer 21 shown in FIG. 1. As shown in FIG. 1, encapsulating layer 21 surrounds all of the layers of exemplary composite assembly 10. In applications such as antiballistic applications, encapsulating layer 21 provides structural integrity to a given composite assembly even after sustaining multiple hits (“strikes” from a projectile such as a bullet).

Encapsulating layer 21 may comprise a variety of materials. Suitable encapsulating layer materials include, but are not limited to, elastomeric materials such as polyurethanes, polyureas, polyurethaneureas, polyvinylchloride, polyesters, polyamides, polyolefins, and combinations thereof. One suitable encapsulating layer material is commercially available from The Sherwin-Williams Company (Cleveland, Ohio) under the trade designation EnviroLastic®.

Encapsulating layer 21 may comprise a single layer of the above-described materials or may comprise two or more layers of the above-described materials. Further, any of the layer(s) used to form encapsulating layer 21 may be optionally reinforced with fibrous material such as those described above. Typically, encapsulating layer 21 in the form of a single or multiple layers has an overall layer thickness of less than about 25 mm. More typically, encapsulating layer 21 in the form of a single or multiple layers has an overall layer thickness of from about 5 to about 10 mm.

Encapsulation layer 21 is desirable in certain conditions to protect the panel from environmental damage and/or to conceal the damage done to a panel in order to confuse potential threats as to the viability of a given structure.

F. Additional Layers

The composite assemblies of the present invention may comprise one or more additional layers (not shown in FIG. 1). Suitable additional layers include, but are not limited to, film layers, fiber-containing layers, foam layers, particulate layers, or combinations thereof. Suitable film layers include, but are not limited to, thermosettable and thermoplastic polymeric films. Specific film layers include, but are not limited to, epoxy film layers, toughened epoxy film layers, cyanate ester film layers, polyimide film layers, bismaleimide (BMI) resin film layers, polyester film layers, polypropylene film layers, and combinations thereof. Suitable fiber-containing layers include, but are not limited to, the above-described fiber-containing layers either alone or coated and/or impregnated with a thermosettable resin (e.g., epoxy resin) and/or a thermoplastic material (e.g., polypropylene) as described above.

### II. Methods of Making Composite Assemblies

The present invention is also directed to methods of making composite assemblies comprising one or more of the above-described layers. In one exemplary method of making a composite assembly of the present invention, the method comprises the steps of bonding a first skin layer to a first major outer surface of a compartmentalized layer having a plurality of compartments extending substantially perpendicular to the first skin layer; filling the plurality of compartments with particulate material and an optional matrix material so that the particulate material occupies a majority of total compartment volume within the compartmentalized layer; and bonding a second skin layer to a second major outer surface of the compartmentalized layer opposite the first skin layer.

In this exemplary method, the step of filling the plurality of compartments with particulate material and an optional matrix material may comprise placing the compartmentalized layer on a vibration table; filling the plurality of compartments with a first particulate material having a first average particle size while vibrating the compartmentalized layer; filling the plurality of compartments with a second particulate material having a second average particle size less than the first average particle size while vibrating the compartmentalized layer; optionally filling the plurality of compartments with a third particulate material having a third average particle size less than the first and second average particle sizes while vibrating the compartmentalized layer; and pouring a low viscosity polymeric resin material (e.g., methyl methacrylate) into the plurality of compartments to fill any voids between the particulate material. Depending on the type of resin used, the exemplary method may further comprise hardening the resin by cooling the resin (e.g., thermoplastic resin) or by curing the resin (e.g., thermosettable resin).

In an alternative step of the above exemplary method, the step of filling the plurality of compartments with particulate material and an optional matrix material may comprise forming shapes of particulate material in a matrix material, wherein the formed shapes are subsequently placed within the plurality of compartments. In this alternative method step, the step of forming shapes may comprise any molding or shaping step (e.g., extrusion) suitable for forming shapes that match and desirably fit tightly within the plurality of compartments.

In yet a further alternative method, the individually formed shapes may be arrayed in place so that a space is provided between each of the adjacent shapes and a casting resin (e.g., a polymeric material, metal material or other matrix type material) may be poured over the shapes and allowed to drain into or be drawn into the spaces between the adjacent shapes thereby forming the confining walls described above. Suitable matrix materials may be metallic, polymeric, organic or inorganic in nature.

In a further exemplary method of making a composite assembly of the present invention, the method comprises the steps of forming a first layer comprising ten or more woven aramid fabrics within a first thermoplastic resin matrix; forming a second layer comprising one or more woven carbon fabrics within a second thermoplastic resin matrix; forming a third layer comprising one or more woven carbon fabrics within a third thermoplastic resin matrix; and combining the first, second and third layers with one another so as to sandwich the first layer between the second and third layers. In this exemplary method, the steps of forming a fabric in a resin matrix may comprise any conventional method of coating and/or impregnating a resin into a fabric including, but not limited to, immersing a fabric into a resin material (e.g., dip coating), coating fibers with a resin material prior to weaving a given fabric, sandwiching fabric layers between resin film layers and applying heat and/or pressure to force resin material into the fabric, etc. The step of combining first, second and third layers to one another may comprise any conventional lamination/bonding step such as those that apply heat, pressure or both to the first, second and third layers.

Any of the above-described exemplary methods of making a composite assembly of the present invention may further comprise one or more additional method steps. Suitable additional method steps include, but are not limited to, forming a compartmentalized layer from one or more continuous structures (e.g., forming a honeycomb structure); removing any particulate material extending beyond a major outer surface of the compartmentalized layer; applying a second skin layer to the compartmentalized layer prior to or after hardening of any matrix material within the plurality of compartments; optionally compressing the filled compartmentalized layer to form a densified compartmentalized layer; assembling a plurality of filled compartmentalized layers or densified compartmentalized layers along an outer surface of a layer (e.g., along an outer surface of fiber-reinforced structural layer 12) so as to substantially cover the outer surface of the layer (see, for example, FIG. 3); bonding one or more compartmentalized layers or densified compartmentalized layers to one or more additional composite assembly layers, such as a fiber-reinforced structural layer (e.g., fiber-reinforced structural layer 12), to form a composite assembly; assembling a plurality of composite assemblies, each of which comprises (i) a filled compartmentalized layer or a densified compartmentalized layer and (ii) a fiber-reinforced structural layer, along an outer surface of a structure so as to substantially cover the outer surface of the structure (see, for example, FIG. 4); bonding one or more compartmentalized layers or densified compartmentalized layers to (i) a fiber-reinforced structural layer (e.g., fiber-reinforced structural layer 12) via (ii) an adhesive layer (e.g., adhesive layer 18), and (iii) a surface layer (e.g., surface layer 15), and optionally encapsulating the resulting structure within an encapsulating layer (e.g., encapsulating layer 21) to form a desired composite assembly; and assembling a plurality of the desired composite assemblies along an outer surface of a structure so as to substantially cover the outer surface of the structure (see, for example, FIG. 4).

When the filled compartmentalized layer is compressed to form a densified compartmentalized layer, the filled compartmentalized layer is typically compressed using a hydraulic press at a pressure ranging from about 996 kiloNewtons (kN) (100 tons) to about 1245 kN (125 tons). However, it is to be understood that any desired amount of pressure may be used so as to result in a desired compartmentalized layer density, which can be as much as 2.0 g/cm³.

When the composite assembly comprises an encapsulating layer (e.g., encapsulating layer 21), the encapsulating layer may be applied over the remaining layers of a given composite assembly by any known coating method including, but not limited to, spray coating, dip coating, etc. In one desired embodiment, a spray coating step is used to apply a uniform application of vaporized coating material or finely divided droplets of coating material in order to uniformly cover one or more outer surfaces of the panel.

### III. Methods of Using Composite Assemblies

The present invention is further directed to methods of using composite assemblies in a variety of applications. Suitable applications include, but are not limited to, antiballistic applications for any type of vehicle or building structure. In one exemplary embodiment, the method of using a composite assembly comprises a method of providing antiballistic protection to an article, wherein the method comprises the steps of positioning the composite assembly between a projectile source and the article. The projectile source may comprise a gun, rifle, antiballistic missile launcher, etc.

In one desired embodiment of the present invention, the composite assemblies are used to provide antiballistic protection to commercial and military vehicles due to the overall relatively low basis weight and overall thickness of the composite assemblies. For example, the composite assemblies of the present invention may have an overall basis weight of less than about 97.6 kg/m² (20 lb/ft²) and an overall thickness of less than 5.1 cm (2 in) and still provide antiballistic protection to a structure (e.g., a military vehicle) from a Level III projectile (e.g., 7.62 mm FMJ bullets).

FIGS. 3 and 4 provide exemplary constructions of composite assembly systems. As shown in FIG. 3, composite assembly system 100 covers an outer surface 51 of structure 50. Composite assembly system 100 comprises a plurality of confined particulate structural layer 11 along an outer surface 121 of fiber-reinforced structural layer 12. In another construction as shown in FIG. 4, composite assembly system 200 covers an outer surface 51 of structure 50. However, in this exemplary embodiment, composite assembly system 100 comprises a plurality of confined particulate structural layer 11 along a plurality of outer surfaces 121 of a plurality of fiber-reinforced structural layers 12.

In one desired embodiment of the present invention, the composite assemblies of the present invention has a structure similar to exemplary composite assembly 10 as shown in FIG. 1. This composite assembly comprises (i) a densified confined particulate structural layer (e.g., confined particulate structural layer 11) having a layer density of about 2.0 g/cm³ and comprising an aluminum honeycomb structure filled with about 70 to about 100 wt % silicon carbide particles and an optional resin binder (e.g., methyl methacrylate resin or nylon 6) of from about 0 to about 30 wt % based on a total weight of the confined material or shapes, (ii) a fiber-reinforced structural layer (e.g., fiber-reinforced structural layer 12) comprising a first layer comprising about 85 wt % of from about 26 to about 35 woven KEVLAR® fabrics and about 15 wt % of a polyolefin resin matrix (e.g., polypropylene or ethylene-propylene copolymer), a second layer comprising about 65 wt % of from about 1 to about 4 woven carbon fabrics and about 35 wt % of a nylon 6 resin matrix, and a third layer comprising about 65 wt % of from about 1 to about 4 woven carbon fabrics and about 35 wt % of a nylon 6 resin matrix; (iii) an adhesive layer (e.g., adhesive film layer 18) comprising a polyolefin adhesive film having an original film thickness of about 76.2 μm (3 mil); and (iv) a surfacing film layer (e.g., surfacing film layer 15) comprising from about 1 to about 4 woven carbon fabrics and about 35 wt % of a nylon 6 resin matrix. As described above, an encapsulating layer (e.g., encapsulating layer 21) may also be included and may comprise, for example, a polyurethane or polyurea layer having an original layer thickness of about 7 mm. In this desired embodiment, the resulting composite assembly has an overall basis weight ranging from about 73.2 kg/m² (15 lb/ft²) to about 87.9 kg/m² (18 lb/ft²), and an overall thickness of from about 4.0 cm to about 6.0 cm.

The resulting desired composite assemblies are capable of providing exceptional antiballistic properties to structures such as military vehicles and building components, while maintaining a desired minimum overall thickness and basis weight. In one desired embodiment, the composite assemblies of the present invention are capable of providing ballistic strike protection from multiple strikes from a Level III projectile without sustaining complete penetration to a composite assembly surface opposite the strike face (e.g., strike face surface 16 shown in FIG. 1). In one exemplary embodiment, the composite assemblies of the present invention are capable of stopping Level III projectiles traveling at velocities in excess of 1128 m/sec (3700 ft/sec).

In addition to the relatively low overall basis weight and overall thickness, the composite assemblies of the present invention provide exceptional protection from multiple strikes due to the confined particulate structural layer (e.g., confined particulate structural layer 11). Instead of an entire plate or layer disintegrating while struck by a projectile as is the case with ceramic plates, the confined particulate structural layer experiences a relatively low degree of damage when struck by one or more projectiles. When a projectile enters confined particulate structural layer from a strike face side (from direction A in FIG. 1), typically the projectile enters into a single compartment of confined particulate structural layer. Damage to confined particulate structural layer is typically limited to the single compartment or several compartments surrounding the stricken compartment. The remaining portion of the confined particulate strike face layer remains intact so as to withstand additional projectile strikes.

### IV Methods of Repairing Composite Assemblies

The present invention is also directed to methods of repairing composite assemblies exposed to one or more strikes from a projectile. In one exemplary embodiment, the method of repairing a composite assembly comprises refilling one or more compartments within a confined particulate structural layer (e.g., confined particulate structural layer 11) of a composite assembly; and hardening the filling material as needed (e.g., when a hardenable matrix material is present). In the exemplary method of repairing a composite assembly, the step of refilling one or more compartments may comprise injecting particulate, a particulate-filled thermoplastic resin, or a cementitious matrix material into the one or more compartments through one or more exterior layers (e.g., surfacing film layer 15, encapsulating layer 21, or both). In another exemplary method of repairing a composite assembly, the step of refilling one or more compartments may comprise inserting a preformed shape (described above) into the one or more compartments through one or more exterior layers (e.g., surfacing film layer 15, encapsulating layer 21, or both).

The method of repairing a composite assembly may further comprise one or more additional method steps. Suitable additional method steps include, but are not limited to, inspecting an outer strike surface of a composite assembly for projectile holes; inserting a nozzle/conduit through one or more exterior layers (e.g., surfacing film layer 15, encapsulating layer 21, or both) and into one or more compartments; removing portions of one or more exterior layers (e.g., surfacing film layer 15, encapsulating layer 21, or both) to gain access to one or more damaged compartments; and reattaching or replacing portions of one or more exterior layers (e.g., surfacing film layer 15, encapsulating layer 21, or both) previously removed in order to gain access to one or more damaged compartments or damaged by a projectile.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of a Confined Particulate Structural Layer

First and second confined particulate structural layers similar to exemplary confined particulate structural layer 11 of exemplary composite assembly 10 shown in FIG. 1 were prepared as follows. A resin impregnated woven carbon fabric (TowFlex® TFF AS4 491: 2×2 TW/N6 38% commercially available from Hexcel Corporation (Stamford, Conn.)) was bonded to one major outer surface of a 2.54 cm thick honeycomb layer (Hexcel Aluminum ACG-1/2 commercially available from Hexcel Corporation (Stamford, Conn.)) using a polyolefin adhesive commercially available from Bemis Corporation (Shirley, Mass.) under the trade designation 6340 polyolefin adhesive. Silicon carbide particles commercially available from Saint Gobain (Louisville, Ky.) under the trade designation SIKATECH 15FCPC were poured into the plurality of compartments within the honeycomb layer. The particles were hand compacted into the compartments and the honeycomb layer vibrated in order to minimize the voids in the plurality of compartments. A second resin impregnated woven carbon fabric (TowFlex® TFF AS4 491: 2×2 TW/N6 38%) was bonded to the other major outer surface of the honeycomb layer to seal the compartments.

The first confined particulate structural layer was used as is to form a first composite assembly. The first confined particulate structural layer had a layer thickness of 25.4 mm, and a density of 1.6 g/cm³.

The second confined particulate structural layer was compacted in a hydraulic press using a compaction pressure of from about 996 kN (100 tons) to about 1245 kN (125 tons). The second confined particulate structural layer had a layer thickness of 19 mm, and a density of 1.7 g/cm³.

### EXAMPLE 2

### Preparation of a Fiber-Reinforced Structural Layer

A fiber-reinforced structural layer similar to exemplary confined particulate structural layer 12 of exemplary composite assembly 10 shown in FIG. 1 was prepared as follows. A first layer was prepared by heat laminating (e.g., hot pressing) 35 resin impregnated woven KEVLAR® fabric layers (Hexcel Hexform VIP™) together. The resulting first layer comprised 85 wt % KEVLAR® fabric material and 15 wt % of a proprietary polyolefin resin from DuPont (Wilmington, Del.). Second and third layers were each independently prepared by heat laminating (e.g., hot pressing) 3 resin impregnated woven carbon fabric layers (TowFlex® TFF AS4 491: 2×2 TW/N6 38%) together. Each of the resulting second and third layers comprised 62 wt % woven carbon fabric and 38 wt % nylon 6 resin. The first layer was then positioned between second and third layers, and heat bonded to one another at a temperature of 177° C. and a pressure of 689.5 kN/m² (100 psi).

The resulting fiber-reinforced structural layer had an overall thickness of 20 mm, and an overall basis weight of 20 kgsm.

### EXAMPLE 3

### Preparation of a Composite Assembly

The confined particulate structural layer formed in Example 1 was adhesively bonded to the fiber-reinforced structural layer formed in Example 2 using a polyurethane adhesive commercially available from (OSI Sealants, Inc. (Mentor, Ohio) a division of Sovereign Specialty Chemicals, Inc. The total assembly was cured overnight in a hydraulic press under 9.96 kiloNewtons (kN) (1 ton) of pressure at ambient temperature. The resulting panel had an overall thickness of 4.5 cm (1.77 in), an overall basis weight of 5.08 g/cm² (10.41 lb/ft²), an overall density of 1.13 g/cm³ (70.55 lb/ft³), and overall side dimensions of 38.1 cm (15 in)×38.1 cm (15 in).

### EXAMPLE 4

### Antiballistic Properties of Composite Assemblies

The composite assembly of Example 3 was tested for antiballistic properties as follows. Panels were tested at United States Test Laboratory (Wichita, Kans.) according to N.I.J. 0108.01 test protocol for a Level III threat. The following test parameters were used as shown in Table 1 below.

TABLE 1
V50 Ballistic Limit Test Parameters

| | |
|---|---|
| Test Parameters: | |
| Ballistic Threat: | |
| Projectile length | 7.62 mm |
| Projectile weight | 148 FMJ |
| Projectile powder | 4064 |
| Barrel length | 66.0 cm (26 in) |
| Obliquity | 0 degrees |
| Test specification | Mil-Std-662F |
| Range Data: | |
| Muzzle to screen 1 distance | 1.66 m (5.46 ft) |
| Screen 1 to screen 2 distance | 1.75 m (5.73 ft) |
| Screen 2 to target distance | 11.86 m (38.9 ft) |
| Target to witness distance | 15.24 cm (0.5 ft) |
| Midpoint to target distance | 12.72 m (41.72 ft) |
| Room Conditions: | |
| Humidity | 33% |
| Temperature | 18.9° C. (66° F.) |

Nine shots were fired at sample composite panels as described above. The test results are provided in Table 2 below.

TABLE 2
V50 Ballistic Limit Test Results

| | | Average | Penetration |
|---|---|---|---|
| | Powder | Velocity | (C = complete, |
| Sample | (g) | mps (fps) | P = partial) |
| 1 | 44.8 | 848.6 (2784) | P |
| 2 | 44.9 | 848.6 (2784) | P |
| 3 | 45.1 | 860.8 (2824) | P |
| 4 | 46.5 | 880.6 (2889) | P |
| 5 | 62.5 | 920.8 (3021) | P |
| 6 | 66.4 | 990.0 (3248) | C |
| 7 | 65.2 | 969.0 (3179) | P |
| 8 | 66.0 | 966.2 (3170) | P |
| 9 | 66.7 | 966.8 (3172) | P |

Average velocity was determined by averaging two velocity measurements taken using separate chronograph devices. The resulting V50 velocity for the exemplary composite of Example 3 was 979.3 mps (3213 fps).

### EXAMPLE 5

### Preparation of Composite Assemblies Having Antiballistic Properties

A confined particulate structural layer similar to exemplary confined particulate structural layer 11 of exemplary composite assembly 10 shown in FIG. 1 was prepared as follows. A resin impregnated woven carbon fabric (TowFlex® TFF AS4 491: 2×2 TW/N6 38% commercially available from Hexcel Corporation (Stamford, Conn.)) was bonded to one major outer surface of a 2.54 cm thick honeycomb layer (Hexcel Aluminum ACG-1/2 commercially available from Hexcel Corporation (Stamford, Conn.)) using a polyolefin adhesive commercially available from Bemis Corporation (Shirley, Mass.) under the trade designation 6340 polyolefin adhesive. Silicon carbide particles commercially available from Saint Gobain (Louisville, Ky.) under the trade designation SIKATECH 15FCPC were treated with a PVC plastisol under the SEP designation available from Rutland Plastic Technologies (Pineville, N.C.). Treated powder was dried at 107° C. (225° F.) for 30 minutes. The particles were then poured into the plurality of compartments within the honeycomb layer and hand compacted into the compartments.

The packed honeycomb tile was then crushed in a hydraulic press to achieve maximum density. The resulting tile was cured at 177° C. (350° F.) for 30 minutes. A second resin impregnated woven carbon fabric (TowFlex® TFF AS4 491: 2×2 TW/N6 38%) was bonded to the other major outer surface of the honeycomb layer to seal the compartments.

The confined particulate structural layer formed above was adhesively bonded to the fiber-reinforced structural layer formed in Example 2 using a polyurethane adhesive commercially available from OSI Sealants, Inc. (Mentor, Ohio) a division of Sovereign Specialty Chemicals, Inc. The total assembly was cured overnight in a hydraulic press under 9.96 kiloNewtons (kN) (1 ton) of pressure at ambient temperature. The resulting panel had an overall thickness of 3.6 cm (1.41 in), an overall basis weight of 4.89 g/cm² (10.01 lb/ft²), an overall density of 1.36 g/cm³ (85.21 lb/ft³), and overall side dimensions of 34.3 cm (13.5 in)×36.8 cm (14.5 in).

The composite assembly of Example 5 was tested for antiballistic properties as follows. Panels were tested at United States Test Laboratory (Wichita, Kans.) according to N.I.J. 0108.01 test protocol for a Level III threat. The following test parameters were used as shown in Table 3 below.

TABLE 3
V50 Ballistic Limit Test Parameters

| | |
|---|---|
| Test Parameters: | |
| Ballistic Threat: | |
| Projectile length | 7.62 mm |
| Projectile weight | 148 FMJ |
| Projectile powder | 4064 |
| Barrel length | 61.0 cm (24 in) |
| Obliquity | 0 degrees |
| Test specification | Mil-Std-662F |
| Range Data: | |
| Muzzle to screen 1 distance | 1.64 m (5.38 ft) |
| Screen 1 to screen 2 distance | 1.75 m (5.73 ft) |
| Screen 2 to target distance | 11.86 m (38.9 ft) |
| Target to witness distance | 15.24 cm (0.5 ft) |
| Midpoint to target distance | 12.73 m (41.76 ft) |
| Room Conditions: | |
| Humidity | 49% |
| Temperature | 21.7° C. (71° F.) |

Nine shots were fired at sample composite panels as described above. The test results are provided in Table 4 below.

TABLE 4
V50 Ballistic Limit Test Results

| | | Average | Penetration |
|---|---|---|---|
| | Powder | Velocity | (C = complete, |
| Sample | (g) | mps (fps) | P = partial) |
| 1 | 44.8 | 861.7 (2827) | P |
| 2 | 46.0 | 870.5 (2856) | C |
| 3 | 45.5 | 871.7 (2860) | C |
| 4 | 44.5 | 847.3 (2780) | P |
| 5 | 45.0 | 861.7 (2827) | P |
| 6 | 45.5 | 868.4 (2849) | P |
| 7 | 46.2 | 878.1 (2881) | P |
| 8 | 46.6 | 881.2 (2891) | C |
| 9 | 46.6 | 890.9 (2923) | C |

Average velocity was determined by averaging two velocity measurements taken using separate chronograph devices. The resulting V50 velocity for the exemplary composite of Example 5 was 872.9 mps (2864 fps).

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A composite assembly comprising:
a confined particulate structural layer comprising first and second major outer surfaces and a plurality of wall portions extending from said first major outer surface to said second major outer surface so as to form a plurality of compartments within said confined particulate structural layer;
a confined material positioned within said plurality of compartments, said confined material comprising particulate material and an optional first matrix material, said optional first matrix material comprising an inorganic matrix material or an organic polymeric resin material;
wherein said confined material comprises greater than about 85 wt % particulate material, and occupies from about 50 to about 95 vol % of a compartment volume of said plurality of compartments; and
a fiber-reinforced structural layer on at least one of said first and second outer major surfaces, said fiber-reinforced structural layer comprising a first layer comprising one or more fabric layers within a second matrix material, and second and third layers on opposite major surfaces of said first layer, wherein each of said second and third layers independently comprises one or more fiber-containing structures within third and fourth matrix materials respectively.

2. The composite assembly of claim 1, wherein said wall portions comprise a honeycomb structure.

3. The composite assembly of claim 2, wherein said honeycomb structure comprises aluminum or stainless steel.

4. The composite assembly of claim 1, wherein said wall portions are compressed such that an average length of said wall portion is greater than a distance from said first outer major surface to said second major outer surface.

5. The composite assembly of claim 1, wherein said first layer comprises from about 25 to about 55 aramid layers within a second matrix material, and each of said second and third layers independently comprise from 1 to 10 woven carbon fabric layers.

6. The composite assembly of claim 5, wherein said first layer comprises less than about 40 wt % of said second matrix material based on a total weight of said first layer, said second layer comprises greater than about 30 wt % of said third matrix material based on a total weight of said second layer, and said third layer comprises greater than about 30 wt % of said fourth matrix material based on a total weight of said third layer.

7. The composite assembly of claim 5, wherein said first layer comprises from about 15 to about 20 wt % of said second matrix material based on a total weight of said first layer, said second layer comprises from about 30 to about 60 wt % of said third matrix material based on a total weight of said second layer, and said third layer comprises from about 30 to about 60 wt % of said fourth matrix material based on a total weight of said third layer.

8. The composite assembly of claim 5, wherein said second matrix material comprises a polyolefin, said third matrix material comprises a polyamide matrix material, and said fourth matrix material comprises a polyamide matrix material.

9. The composite assembly of claim 1, wherein said fiber-reinforced structural layer is on said first outer major surface and said composite assembly further comprises a surfacing film comprising a fifth resin matrix material with or without fiber reinforcement on said second major outer surface.

10. The composite assembly of claim 9, further comprising an adhesive film layer between said confined particulate structural layer and said fiber-reinforced structural layer.

11. The composite assembly of claim 10, further comprising an encapsulating layer surrounding said confined particulate structural layer, said fiber-reinforced structural layer, said surfacing film, and said adhesive film layer.

12. The composite assembly of claim 11, wherein said encapsulating layer comprises polyurethane, polyurea, polyurethaneurea, polyvinyl-chloride, polyamide, polyester, or a combination thereof.

13. The composite assembly of any one of claim 1, wherein said confined material comprises loose particulate material.

14. A composite assembly comprising:
a confined particulate structural layer comprising first and second major outer surfaces and a plurality of wall portions extending from said first major outer surface to said second major outer surface so as to form a plurality of compartments within said confined particulate structural layer;
a confined material positioned within said plurality of compartments, said confined material comprising particulate material within a first matrix material, said first matrix material comprising an inorganic matrix material or an organic polymeric resin material;
wherein said confined material comprises greater than about 85 wt % particulate material, and occupies from about 50 to about 95 vol % of a compartment volume of said plurality of compartments; and
a fiber-reinforced structural layer on at least one of said first and second outer major surfaces, said fiber-reinforced structural layer comprising:
a first layer comprising from about 25 to about 55 woven aramid fabric layers within a second matrix material,
a second layer on one major surface of said first layer, said second layer comprising from 1 to 10 woven carbon fabric layers within a third matrix material, and
a third layer on said first layer opposite said second layer, said third layer comprising from 1 to 10 woven carbon fabric layers within a fourth matrix material.

15. The composite assembly of claim 14, wherein said first layer comprises from about 15 to about 20 wt % of a polyolefin matrix material based on a total weight of said first layer, said second layer comprises from about 30 to about 60 wt % of a polyamide matrix material based on a total weight of said second layer, and said third layer comprises from about 30 to about 60 wt % of a polyamide matrix material based on a total weight of said third layer.

16. The composite assembly of claim 14, wherein said first matrix material comprises a thermoplastic polymeric resin material.

17. The composite assembly of claim 14, further comprising an adhesive film layer between said confined particulate structural layer and said first major outer surface of said fiber-reinforced structural layer; a surfacing film comprising a fifth resin matrix material with or without fiber reinforcement on said second major outer surface; and an encapsulating layer surrounding said fiber-reinforced structural layer, said confined particulate structural layer, said surfacing film, and said adhesive film layer.

18. A vehicle comprising the composite assembly of claim 1.

19. A method of providing antiballistic protection to an article, said method comprising the steps of:
positioning the composite assembly of claim 1 between a projectile source and the article.

20. The method of claim 19, wherein the article comprises a vehicle.
